(19) United States
(12) Patent Application Publication
(10) Pub. No.: US 2005/0236422 A1
(43) Pub. Date: Oct. 27, 2005

(54) PORTABLE APPARATUS FOR MIXING AND DISPENSING VISCOUS MATERIALS

(76) Inventor: Douglas Scott Dutton, Canyon Lake, CA (US)

Correspondence Address: SNELL & WILMER;ONE ARIZONA CENTER, 400 EAST VAN BUREN, PHOENIX, AZ, 850040001, US

(21) Appl. No.: 10/907,584

(22) Filed: Apr. 6, 2005

Related U.S. Application Data
(60) Provisional application No. 60/559,460, filed on Apr. 6, 2004.

(51) Int. Cl. G01F 11/00; B67D 5/62

(52) U.S. Cl. 222/1; 222/146.5

(57) ABSTRACT

An apparatus for mixing and dispensing plural component viscous materials which includes separate tanks for material components, separate fluid pumps in communication with the separate tanks, means for driving the fluid pumps, and separate heaters in fluid communication with each fluid pump. The apparatus may also include separate heated transfer hoses for transferring plural heated material components to a dispensing assembly such as a spray gun. A method for mixing and dispensing viscous materials includes pumping separate material components through their own separate heaters and may also include pumping the heated material components through their own separate heated transfer hoses.

### CROSS-REFERENCE TO RELATED APPLICATIONS

This application claims the benefit and priority of U.S. provisional patent application having Ser. No. 60/559,460 filed Apr. 6, 2004 which is herein incorporated by reference.

### FIELD OF INVENTION

The present invention relates generally to a method and apparatus for mixing and dispensing viscous materials. More specifically, the present invention relates to a method and apparatus for transferring, mixing and dispensing viscous coating materials which includes separate tanks for a resin and an activator and an electric motor/gear reduction box assembly for driving separate hydraulic fluid pumps for each of the resin and activator. The separate hydraulic fluid pumps pump the resin and the activator through separate inline heaters and separate heated hydraulic fluid hoses to separate control shutoff valves.

### BACKGROUND OF INVENTION

The demand for protective coatings in various industries has long been established. The petroleum industry, the food production industry, and building and manufacturing industries are just some of the industries in which protective coatings are used. Coating materials are used to protect concrete, wood, metal, or plastic surfaces from chemical and/or mechanical attack and are also used in the fabrication of molded and cast products. As a result, these coatings protect against the deterioration of floors, walls, ceilings, and roofing and also are used to produce molded products that are corrosion resistant.

A variety of tools are used for dispensing and applying coatings to a variety of surfaces. These tools include, but are not limited to, spray equipment, paint rollers, brushes and squeegees. Spray equipment is frequently used because it generally facilitates material application and project turn around time which benefits both the applicator and the end user of the product. A myriad of protective coating application scenarios exist that would suggest the need for a type of dispensing equipment that is capable of dispensing materials in various amounts to satisfy a range of project demands such as from coating a large floor area to coating a piping system with a very narrow surface area.

Coating materials such as plural component urethanes and two component epoxies are often dispensed with a spray gun, or are pumped and poured through a nozzle. These plural component materials are used to protect surfaces such as concrete, wood, steel, or plastic and are also used in the fabrication of molded products. They may be dispensed in high volume or low volume quantities. High volume dispensing of urethanes and epoxies often requires a large air source and high air pressure to operate the dispensing system. For example, high volume dispensing applications typically require a minimum of 7 to 30 CFM at 250-3000 psi of air pressure which in turn demands the use of a 220 volt air compressor and spraying apparatus. These requirements can make portability of the apparatus used for such applications difficult.

Although low volume dispensing equipment may be more portable, low volume dispensing units may be too slow for large application areas. Moreover, when high volume dispensing equipment is used in low volume applications to spray small surface areas, increased costs result from the loss of over-sprayed coating materials. The need to regulate coating material output is essential to saving both time and money. Accordingly, there is a need for a portable dispensing apparatus that is capable of spraying or pouring plural component coating materials in a wide range of low to high volume.

### SUMMARY OF INVENTION

The present invention is directed to an apparatus for mixing and dispensing viscous materials, and in particular coating or casting materials, which includes a separate reservoir or tank for each component of the coating material, a separate fluid pump in fluid communication with each reservoir or tank, means for driving the fluid pumps, and a separate heater for each component that is in fluid communication with each fluid pump. In one embodiment, the means for driving the fluid pump is an electric motor which may include a reduction gear box assembly.

The apparatus of the present invention may also include a separate heated transfer hose for each heated component where each separate heated transfer hose is in fluid communication with each heater. In one exemplary embodiment, the heated transfer hoses are encased within a layer of aluminum foil, which is in turn encased within a layer of heating element, which is encased within an insulator layer, which is in turn encased within a plastic sheath. All four of these layers extend along a length of the transfer hoses. In addition, an air supply hose may be encased within the plastic sheath between the insulator layer and the plastic sheath.

A housing on wheels for containing the reservoirs, fluid pumps, means for driving the fluid pumps, and heaters may also be included as part of the apparatus of the present invention. The wheels on the housing make the apparatus mobile and portable. The housing may include a storage compartment contained within or on the housing to store the heated transfer hoses which can be disconnected from an electrical circuit contained within the housing. The apparatus of the present invention may also include a spray gun assembly or other device for mixing and dispensing the heated components. The ends of the heated transfer hoses which are not connected to the electrical circuit are connected to the spray gun assembly and, when disassembled, the spray gun assembly may also be stored in the storage compartment of the housing.

Other elements of the apparatus of the present invention may include a separate fluid filter device located between each reservoir and fluid pump, a separate check valve in fluid communication with each fluid pump, a separate fluid pressure switch for each fluid pump that is in communication with the electric motor, a separate hose connector for each heated transfer hose which connects the heated transfer hose to an electrical circuit within the housing of the apparatus, a step up or step down transformer, and a remote control device for controlling the speed of the electric motor.

The present invention is also directed to a method for mixing and dispensing viscous materials comprising the steps of placing separate components for making a coating material or casting material into separate reservoirs or tanks, pumping the separate components through separate heaters which are in fluid communication with the separate reservoirs, mixing the separately heated components, and dispensing the heated mixture. The method of the present invention may also include the step of pumping each of the heated components through separate heated transfer hoses after pumping the components through the heaters. The mixing and dispensing steps may be performed with any standard spray gun assembly that is capable of missing separate components within the assembly and then releasing the mixed components.

### BRIEF DESCRIPTION OF THE DRAWINGS

A more complete understanding of the present invention may be derived by referring to the detailed description and claims when considered in connection with the following illustrative Figures, where like reference numbers refer to similar elements throughout the Figures.

FIG. 1 is a schematic showing the elements of the fluid transfer system of the mixing and dispensing apparatus of the present invention.

FIG. 2 is a lengthwise cross-section of the heated transfer hoses and air supply hose of the mixing and dispensing apparatus of the present invention.

FIG. 3 is a vertical cross-section of the heated transfer hoses and air supply hose of the mixing and dispensing apparatus of the present invention.

FIG. 4 is a perspective view of the portable mixing and dispensing apparatus of the present invention.

FIG. 5 is a front planar view of the portable mixing and dispensing apparatus shown in FIG. 4.

FIG. 6 is a front planar view of the portable mixing and dispensing apparatus of the present invention shown with the walls of the housing removed to illustrate the location of the elements of the invention that are contained within the housing.

FIG. 7 is a back planar view of the portable mixing and dispensing apparatus shown in FIG. 4.

### DETAILED DESCRIPTION

In general, the present invention is directed to a method and apparatus for mixing and dispensing plural component viscous materials and in particular plural component viscous coating or casting materials. The apparatus of the present invention is mobile and portable and capable of dispensing low to high volumes of coating or casting materials at low volume pressure rates of about 100 psi to high volume pressure rates of about 3000 psi. The apparatus can dispense coating or casting materials having a viscosity within a range of about 50 to 3000 centipoises and set times within a range of about one second to twenty four hours.

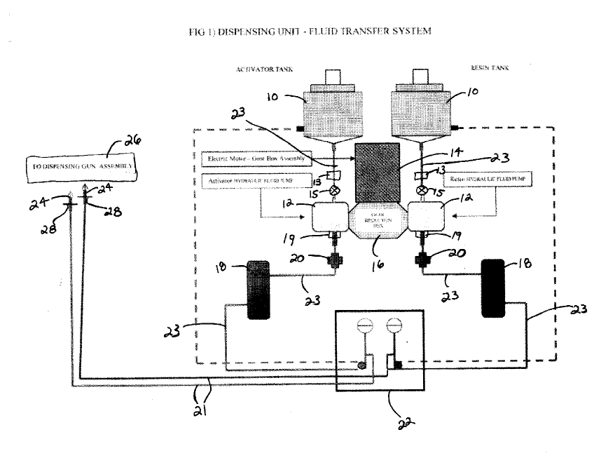

FIG. 1 shows a schematic of the fluid transfer system of the mixing and dispensing apparatus of the present invention. The apparatus of the present invention includes at least two reservoirs (or tanks) 10 that are in fluid communication with respective fluid pumps 12. Reservoirs 10 contain plural components for making viscous materials such as coating or casting materials. For example, in FIG. 1, one reservoir (tank) may include an activator component and another reservoir (tank) may include a resin component. Means for driving fluid pumps 12, such as an electric motor 14 with a gear reduction box 16, is in communication with fluid pumps 12. A separate fluid filter device 13 for each of the material components may be positioned in fluid communication between reservoirs or tanks 10 and fluid pumps 12 and a separate check ball device 15 may also be located between each of the reservoirs or tanks 10 and fluid pumps 12 to prohibit material components from back charging into their respective reservoirs or tanks in the event that the system's drive train mechanism causes “back pressure”. Each separate fluid pump 12 is in fluid communication with a separate heater 18 and the material components are pumped into their respective heaters 18.

Fluid pumps 12 may be hydraulic fluid pumps that are capable of controlling the flow rates of the material components from a low volume fluid pressure of about 100 psi to a high volume fluid pressure of about 3000 psi. The fluid pumps do not release pressure when the material components are not being dispensed or when the system is in the “off trigger” mode. Separate electronic fluid pressure switches 19 are located on the outflow side of each of the fluid pumps 12 and are in communication with electric motor 14. These electronic fluid pressure switches are adjustable and preset to shut off the electric motor 14 at a predetermined fluid pressure level of between about 0 psi and 3000 psi.

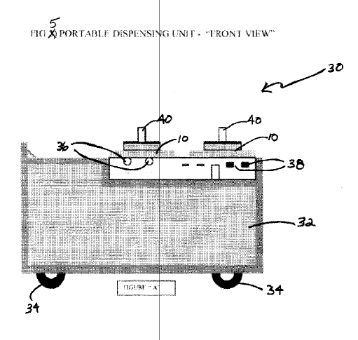

A separate check valve or check ball device 20 may be positioned in fluid communication with, and between, each of the fluid pumps 12 and heaters 18 to prevent the respective fluid components from back-charging into the fluid pumps 12. Each separate heater 18 is in fluid communication with a separate heated transfer hose 21 and the material components are pumped from the heaters 18 through their respective heated transfer hoses 21. An electrical connector 22 for the attachment of the heated transfer hoses 21 is connected to an electrical circuit located within the housing of the apparatus (See FIG. 4) such that a user has access to connect and disconnect the heated transfer hoses 21 from the electrical circuit. Lines 23 represent fluid communication lines through which the material components flow.

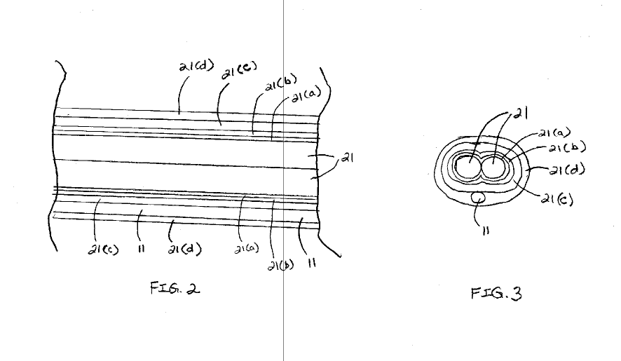

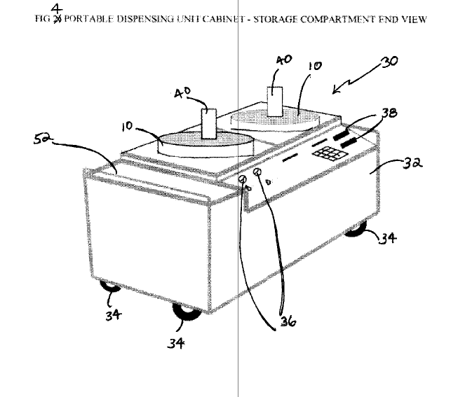

FIG. 2 shows a lengthwise cross-section of the heated transfer hoses 21 and an air supply hose 111 and FIG. 3 shows a vertical cross-section of heated transfer hoses 21 and air supply hose 11. As shown in FIGS. 2 and 3, heated transfer hoses 21 are encased within a layer of aluminum foil 21(a) which is in turn encased within a layer of heating element 21(b). The heating element may comprise a heat tape, a heat cable, or any other similar heating mechanism known in the industry. The aluminum foil 21(a) dissipates the heat evenly over the hoses. The aluminum foil 21(a) and heating element 21(b) run along an entire length of the transfer hoses such that the heating element 21(b) encloses and covers the outer surface area of the hoses 21. Heating element 21(b) functions to heat the transfer hoses 21 and to maintain the heat generated by the inline fluid heaters 18. An insulator layer 21(c), such as foam rubber for example, encases the layer of heating element 21(b) and a plastic sheath 21(d) encases the insulator layer 21(c). Both the insulator layer 21(c) and the plastic sheath 21(d) run along an entire length of the hoses 21. An air supply tube 11, which is connectable to a compressor, encapsulated within the plastic sheath 21(d) between the insulator layer 21(c) and the plastic sheath 21(d).

Ends 24 of heated transfer hoses 21 are connected to a dispensing assembly such as a spray gun assembly 26 and separate fluid control valves 28, which may be hydraulic, are each connected to separate ends 24. Fluid control valves 28 are opened during the dispensing mode and closed when the apparatus is not dispensing or when the spray gun assembly is in the “off trigger” position.

The spray gun assembly 26 may comprise any standard spray gun assembly for plural components that is known in the industry having a spray tip containing orifice sizes and shapes that can be adjusted or changed to control atomization of a mixed viscous material and the spray or flow pattern of the material. The spray gun assembly 26 preferably includes a side block for a resin component and a side block for an activator component, each of which introduce the components into a common mixing chamber for mixing the components together. Each of the side blocks includes a separate hydraulically operated check valve which is pressure activated to open when the spray gun trigger is depressed and to close when the spray gun trigger is released. When the spray gun trigger is depressed, the check valves open under pressure and force each of the respective components at the same or diverse flow rates into the mixing chamber of the spray gun where the two components are blended into a homogenous material which is then forced under pressure out of the dispensing tip of the spray gun. After dispensing of the homogenous mixture is completed, flow control valves 28 located at the ends 24 of heated transfer hoses 20 are closed, and the excess material in the mixing chamber and dispensing tip of the spray gun is air purged from the spray gun.

Turning now to FIG. 4, a perspective view of the portable mixing and dispensing apparatus 30 of the present invention is shown. Apparatus 30 includes a housing 32 on wheels 34 for containing the fluid transfer system shown in FIG. 1. Apparatus 30 also includes pressure controls 36 for fluid pumps 12 (See FIG. 1) and digital heater controls 38 for heaters 18 (See FIG. 1). Reservoirs or tanks 10 which hold material components, such as a resin and an activator for example, are positioned such that at least one of the reservoirs is substantially enclosed within the housing 32. In FIG. 2, both reservoirs 10 are shown substantially enclosed within housing 32. Reservoirs 10 may each include a separate heating sump 40 for heating the separate material components contained within the reservoirs.

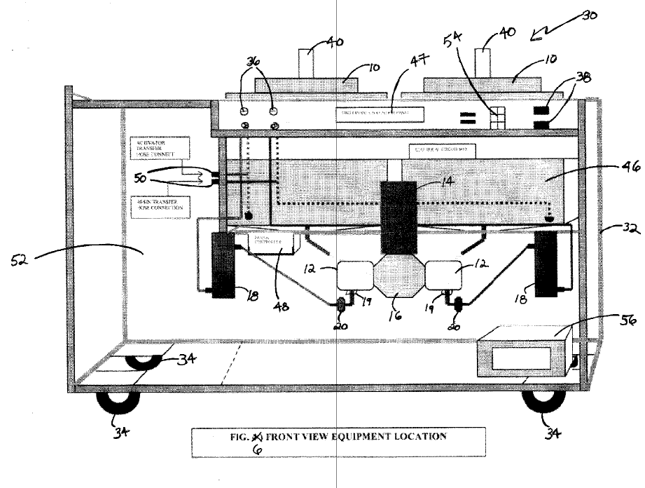

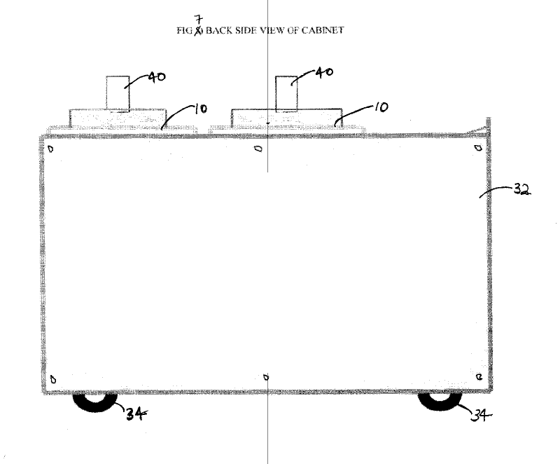

FIG. 5 is a front planar view of the portable mixing and dispensing apparatus 30 of the present invention and FIG. 6 shows the walls of the housing 32 in FIG. 5 removed to illustrate the location of the elements of the invention that are contained within the housing. Apparatus 30 comprises a mobile, portable cabinet on wheels having en enclosed interior. An electrical circuit box 46 contains electrical connections to the fluid pumps 12, electric motor 14, gear reduction box 16, heaters 18, a unit operation control panel 47 which includes pressure controls 36 and digital heater controls 38, a motor controller 48 which includes an automatic pressure switch shutoff control that is in electrical communication with the electric motor 12, and separate electrical connectors 50 for connecting the heated transfer hoses 21. The electrical connectors 50 may comprise 20 ampere electrical receptacles. Apparatus 30 may also include at least one storage compartment or storage area 52 (also see FIG. 1) for storing heated transfer hoses 21 and spray gun assembly 26 when disconnected and not in use.

Apparatus 30 may also include a remote control device 54 connected to electric motor 14 via a cable and a step up or step down power transformer 56 which may comprise between a 1000 and 10,000 watt capacity. It is also contemplated that the device will include ground fault circuit interrupters and a double pull circuit breaker.

FIG. 7 shows a back planar view of the mixing and dispensing apparatus of the present invention shown in FIG. 4.

In brief, the mixing and dispensing apparatus of the present invention includes a fluid system and electrical system contained within a portable housing. The fluid system includes at least two reservoirs for holding separate material components, a separate fluid pump for each reservoir, means for driving the fluid pumps and a separate heater for each of the material components that are in fluid communication with the separate fluid pumps. The apparatus may also include a heated transfer hose for each material component for transporting the heated material components to a dispensing system such as a spray gun assembly. In one exemplary embodiment of the apparatus of the present invention, the fluid system and electrical system contain the following components:

Fluid System
(1) Separate tanks for separate material components
(2) Separate filters in fluid communication with the tanks to remove impediments.
(3) Separate hydraulic pumps in fluid communication with the tanks that are driven by an electric motor to pressure force the fluid material components through the dispensing system.
(4) Separate check valves for each material component that are in fluid communication with the separate fluid pumps.
(5) Separate electric inline heaters that are in fluid communication with the hydraulic fluid pumps which function to heat the respective material components to reduce viscosity levels of each component.
(6) Separate fluid control ball valves for each of the fluid material components that are in fluid communication with the separate heaters.
(7) Separate 3000 psi pressure gauges for each of the fluid material components.
(8) Separate digital heater controls for each of the fluid material components.
(9) Separate hydraulic fluid transfer hoses for each of the fluid material components that extend from electrical connectors for the hoses located at the housing to fluid control ball valves located at the ends of the hoses that are connected to a dispensing gun assembly.
(10) Heating element which extends along the entire length of the transfer hoses, foam insulation which encapsulates the heating element and hoses, and a plastic membrane which encapsulates the hoses, heating element, and foam insulation. A layer of aluminum foil may also be included between the transfer hoses and heat tape to assist in evenly dissipating the heat.
(11) Separate fluid control ball valves in fluid communication with the separate heated transfer hoses.
(12) A 125 psi air line.
(13) A standard triggered dispensing gun.
(14) A 6 CFM capacity compressor.

Electric System
(1) Step down electrical power transformer.
(2) Direct drive at least or about 1.5 hp electric motor(s) and gear reduction box.
(3) Digital motor control unit.
(4) Digital heat control unit.
(5) Electrical heating element for transfer hoses.
(6) Electrical outlet.
(7) One double pull 20 ampere circuit breakers.
(8) Two 120 volt electrical outlets.
(9) Two fifty feet 12/3 gage electrical cords.

During one exemplary embodiment of the operation of the apparatus, standard electrical cords are plugged into separate 20 ampere electrical supply outlets and into the designated electrical receptacles 50 located on the invention enclosure or housing 32. The reservoirs or tanks 10, which have air tight seals and desiccant packs, are opened and each tank 10 is filled. Typically, one tank 10 is filled with a resin and the other is filled with an activator. Each material component is gravity fed through fluid transfer lines 23 to separate pre-pump filters 13 and then onto separate hydraulic pumps 12. A circuit breaker located on the operation control panel is set to the “ON” position. The material components are then preheated to the appropriate operating temperature by turning the fluid control ball valves to the “re-circulate” mode which redirects each material component back into its respective reservoir or tank 10. Each material component is gravity fed to its separate fluid pump 12, forced through separate fluid lines 23 to separate electric heaters 18, through fluid lines 23 to separate pressure control ball valves, and through a series of fluid compression fittings back to separate re-circulation inlets located on the side panels of the separate reservoirs or tanks 10. The material component operating temperatures are set using separate digital heater controllers 38. The remote digital power controller 54 which operates the motor control assembly is set to the “run” position and the motor speed is adjusted as desired to drive the fluid pumps 12 and the material components are cycled continuously through the reservoirs or tanks 10 for as much time as is necessary to uniformly and thoroughly heat the material components. This re-circulation heating process reduces the fluid viscosity of the material components to a level that will allow for a homogenous mixing of the material in the mixing chamber of the dispensing gun and assures that spray pattern is achieved when in the “spray” dispensing mode. A spray tip or other dispensing emitter may be affixed to the mixing chamber of the dispensing gun.

Upon completion of the “re-circulate” mode and with the fluid control valves closed at the dispensing gun 26, the fluid control ball valves are turned to redirect the material components to the “dispensing” gun transfer hoses. The dispensing gun is connected to the separate fluid transfer hoses 21 and the “air purge” hose 11 is connected to the air inlet on the gun. The motor controller is adjusted to produce the desired output of between 10 and 100 hertz depending on the fluid components and the type of dispensing operation. The air valve on the dispensing gun 26 is set to the “open position” thereby allowing air to flow through the mixing chamber and dispensing emitter. The fluid control ball valves for the material components are adjusted to equalize the fluid pressure and to assure the proper mix ratio during the dispensing operation. The fluid control valves are then opened to permit the material components to enter separate side block assemblies of the gun assembly at the same fluid pressure. The gun mechanism 26 is triggered displacing the air pressure with fluid pressure of a homogenous mixture of the material components thereby resulting in the dispensation of a thermosetting compound which may be applied to a targeted location. The electrically powered dispensing system eliminates the introduction of air pressure condensation or moisture into the system by eliminating the use of a compressed air generator to drive the output of the material components.

When the dispensing process is completed, the fluid control valves located at the dispensing gun 26 are turned to the “closed” position, the air is reactivated, and the gun trigger is depressed in several short bursts to purge any remaining materials from the mixing chamber and the dispensing tip or emitter. The motor controller 48 can then be adjusted to reduce pressure in the fluid transfer system, and then set to the “off” position with fluid pressure remaining in the system thereby assuring that the transfer system remains closed off to air which may contaminate the material contents.

The gun assembly 26 is then disassembled and cleaned of any remaining materials. The reservoirs or tanks 10 are checked to assure that enough of each of the material components remains in them to avoid the chance for air to migrate into the transfer system. The circuit breaker on the unit operation control panel are then set to the “off” position. The transfer hoses 21 and gun assembly 26 can then be rolled up and placed into the storage compartment 52 of the portable cart.

The present invention has been described with reference to exemplary embodiments. However, those skilled in the art, having read this disclosure, will recognize that changes and modifications may be made to the preferred embodiments without departing from the scope of the present invention. Any changes and modifications are intended to be included within the scope of the present invention, as expressed in the following claims.

1. An apparatus for mixing and dispensing viscous materials comprising:
at least two reservoirs for holding separate material components;
a separate fluid pump in fluid communication with each reservoir;
means for driving the fluid pumps; and
a separate heater in fluid communication with each fluid pump.

2. The apparatus of claim 1 further comprising a separate heated transfer hose in fluid communication with each heater.

3. The apparatus of claim 2 further comprising a separate control shutoff valve in communication with the means for driving the fluid pumps.

4. The apparatus of claim 2 further comprising a spray gun assembly or static mixed tube assembly in fluid communication with an end of each of the heated transfer hoses.

5. The apparatus of claim 4 further comprising a housing on wheels for containing the reservoirs, the fluid pumps, the means for driving the fluid pumps, and the heaters.

6. The apparatus of claim 5 further comprising at least one storage compartment located within or on the housing for storing at least one of the transfer hoses and the spray gun assembly or static mixed tube assembly.

7. The apparatus of claim 1 further comprising a housing on wheels for containing the reservoirs, the fluid pumps, the means for driving the fluid pumps, and the heaters.

8. The apparatus of claim 1 further comprising at least one fluid filter device located between each reservoir and fluid pump.

9. The apparatus of claim 1 wherein the means for driving the fluid pumps comprises at least one of an electric motor/reduction gear box assembly, a solar powered device, an air motor, and a gas motor.

10. The apparatus of claim 1 further comprising at least one automatic pressure shutoff control in communication with the means for driving the fluid pumps.

11. The apparatus of claim 1 further comprising a separate check valve in fluid communication with each fluid pump.

12. The apparatus of claim 1 further comprising a spray gun assembly or static missed tube assembly in fluid communication with the material components after the material components exit the heaters.

13. The apparatus of claim 1 wherein said apparatus is capable of dispensing a coating material or casting material having a set time within a range of about one second to twenty four hours.

14. The apparatus of claim 1 further comprising a separate adjustable fluid pressure switch for each fluid pump which is capable of shutting off the means for driving the fluid pumps at a predetermined fluid pressure.

15. The apparatus of claim 5 further comprising a separate electrical connector for connecting each heated transfer hose to an electrical circuit contained within the housing.

16. The apparatus of claim 15 wherein the heated transfer hoses are encased within a layer of heating element.

17. The apparatus of claim 1 further comprising a heat controller for each heater to control a temperature of each heater.

18. The apparatus of claim 1 further comprising a step up or step down power transformer.

19. The apparatus of claim 1 further comprising a remote device for controlling the means for driving the fluid pumps.

20. A method for mixing and dispensing viscous materials comprising the steps of:
placing separate components for making a coating material or casting material into separate reservoirs;
pumping the separate components through separate heaters that are in fluid communication with the separate reservoirs;
mixing the separately heated components; and
dispensing the heated mixture.

21. The method of claim 20 further comprising the step of pumping each of the heated components through a separate heated transfer hose for each component after pumping the separate components through separate heaters.

22. The method of claim 21 wherein the mixing and dispensing steps are performed with a spray gun assembly or static mixed tube assembly.
